(19) United States
(12) Patent Application Publication
(10) Pub. No.: US 2010/0064034 A1
(43) Pub. Date: Mar. 11, 2010

(54) COMMUNICATION SERVER DEVICE, ADDRESS DETERMINATION METHOD AND ADDRESS DETERMINATION PROGRAM

(75) Inventor: Minoru Nitta, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/542,435

(22) Filed: Aug. 17, 2009

(30) Foreign Application Priority Data
Sep. 11, 2008 (JP) 2008-233875

(51) Int. Cl. G06F 15/177; G06F 15/16

(52) U.S. Cl. 709/220; 709/227

(57) ABSTRACT

A communication server device includes: a management information registration unit for registering at least a combination of virtual addresses and real addresses of a plurality of terminal units as management information in correspondence with a service type and a communication port of the local device; and an address determination unit for searching, upon reception of a communication start request designating the virtual address and the service type of any of the plurality of the terminal units from another terminal unit, the management information with the combination of the virtual address and the service type as a key and determining the real address and the communication port used as a transferee of the communication start request.

### CROSS-REFERENCE TO RELATED APPLICATIONS

This application is based upon and claims the benefit of priority of the prior Japanese Patent Application No. 2008-233875, filed on Sep. 11, 2008 the entire contents of which are incorporated herein by reference.

### FIELD

The present invention relates to a communication server device for providing a plurality of communication services, an address determination method for the communication server device providing the plurality of the communication services and an address determination program.

### BACKGROUND

Conventionally, the communication server interposed for communication between terminal units manages the positional information, i.e. the address information of each communication terminal and executes the process of transferring a communication request between the terminal units to an appropriate callee. In the IP (internet protocol) telephone using SIP (Session Initiation Protocol) stipulated in RFC (Request For Comments) 3261, for example, the real address of a terminal unit is registered in the SIP server (or the callee terminal) by a mechanism called REGISTER.

In this REGISTER, the terminal unit notifies both the virtual address and the real address thereof to the SIP server with the relation of correspondence. In the SIP server, the virtual address and the real address notified are generally managed as a pair in correspondence with each other (Japanese Laid-open Patent Publication No. 2005-269534, for example).

In recent years, a single terminal unit handling a plurality of communication services and notifying the virtual and real addresses for each service to the SIP server has become available. An example is one of the SIP protocol services including VolP (Voice Over IP) for carrying out speech through an IP network and SIMPLE (SIP for Instant Messaging and Presence Leveraging Extensions) in which IM (instant message) for simple information notification is carried out on a single terminal unit (Japanese Patent No. 3830898, for example).

Further, in a terminal using a plurality of communication services, the virtual address included in the pair of the virtual address and the real address notified for each service may be identical with the real address.

In order that the SIP server may handle the pair of virtual and real addresses identical with each other discriminatively for each service, a plurality of processes corresponding to each service have to be executed to separate the receiving port number for each process, or the server housing has to be separated to separate the receiving address for each communication service.

### BRIEF DESCRIPTION OF DRAWINGS

FIG. 1 is a diagram showing the general configuration of a communication system according to an embodiment of this invention;

FIG. 2 is a diagram for explaining the conventional configuration;

FIG. 3 is a diagram for explaining the address management operation performed by an address control unit 12 of a server 10;

FIG. 4 is a diagram for explaining a specific example of an address management table 12b;

FIG. 5 is a diagram for explaining a specific example of the operation of the communication system shown in FIG. 1;

FIG. 6 is a flowchart for explaining the address information registration process executed by a table management unit 12a;

FIG. 7 is a flowchart for explaining the address information determination process executed by an address information determination unit 12c;

FIG. 8 is a diagram showing the general configuration of a communication server device providing the function of integrating a plurality of services;

FIG. 9 is a diagram for explaining a specific example of a callee table 60;

FIG. 10 is a flowchart for explaining the processing operation of a speech transfer service processing unit 64; and

FIG. 11 is a diagram for explaining a program to operate a computer as a communication server device.

### SUMMARY

According to an aspect of the embodiment, a communication server device includes: a management information registration unit for registering at least a combination of virtual addresses and real addresses of a plurality of terminal units as management information in correspondence with a service type and a communication port of the local device; and an address determination unit for searching, upon reception of a communication start request designating the virtual address and the service type of any of the plurality of the terminal units from another terminal unit, the management information with the combination of the virtual address and the service type as a key and determining the real address and the communication port used as a transferee of the communication start request.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

In the conventional technique, a plurality of server housings have to be used or a plurality of processes have to be started in the server device to connect one terminal, and therefore, the problem is posed that the resources for accommodation increase in number.

In addition, since a plurality of processes are operated or the operation is performed with a plurality of housings, the problem is encountered that it is difficult to provide the function of a terminal unit over a plurality of the services. The function over a plurality of services is defined as, for example, a composite service using two protocols including SIP and SIMPLE. A specific example of the service is “to connect to the callee by the extension if the callee stays in the office or by the outside line otherwise without being conscious of the telephone number of the callee on the part of the caller (with one telephone number)”.

In order to solve this problem, according to the device, the method and the program disclosed herein, the combination of the virtual and real addresses of the terminal unit is registered in correspondence with the service type and the communication port of the local device, and upon reception of a communication start request from the terminal unit, the management information is searched with the combination of the virtual address and the service type as a key thereby to determine the real address and the communication port used as a transferee of the communication start request.

The communication server device, the address determination method and the address determination program according to an embodiment of the invention will be explained in detail below with reference to the drawings.

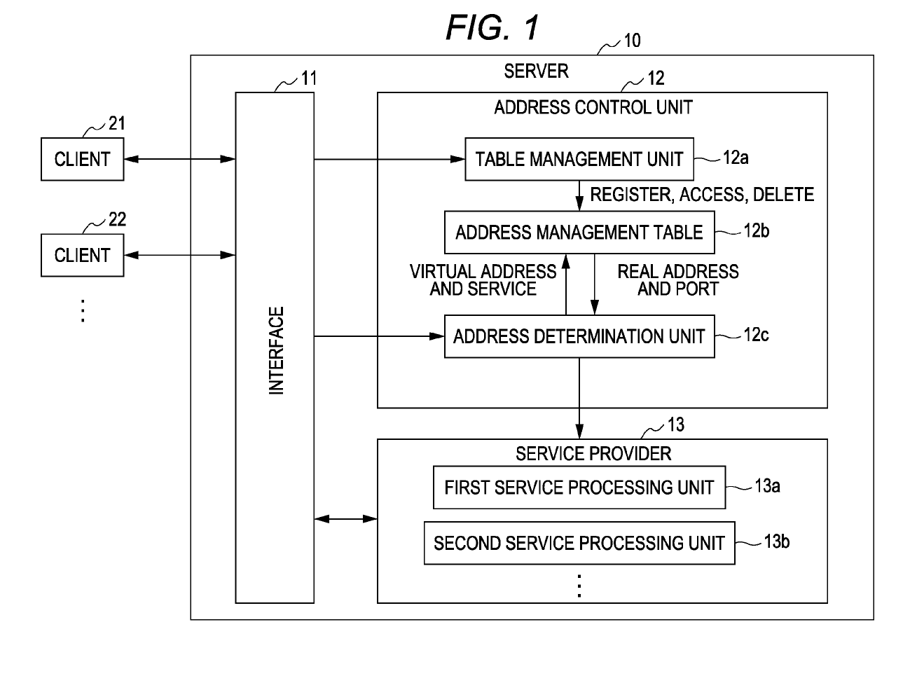

FIG. 1 is a diagram showing the general configuration of a communication system according to this embodiment. The communication system shown in FIG. 1 has a server 10 as a communication server device connected with a plurality of terminal units to provide the communication services between the terminal units.

Specifically, in FIG. 1, the server 10 is connected with clients 21, 22 constituting terminal units. Also, the server 10 has therein an interface 11, an address control unit 12 and a service provider 13.

The interface 11 is a processing unit for connection and communication with the clients 21, 22. The address control unit 12 manages the positional information, i.e. the correspondence between the virtual address and the real address of each client, and in the case where the caller client designates the virtual address of the callee, executes the address determination process to specify the real address of the callee from the designated virtual address.

More specifically, the address control unit 12 has therein a table management unit 12a, an address management table 12b and an address determination unit 12c.

The table management unit 12a functions as a management information registration unit for registering the address information of the clients 21, 22 in the address management table 12b. At the time of registration of the address information, the table management unit 12a further registers the service type and the communication port of the local device in correspondence with each other. Also, the table management unit 12a can access and delete the address information stored in the address management table 12b.

In the address management table 12b, the virtual address, the real address, the service type and the communication port registered by the table management unit 12a are held in correspondence with each other as the management information.

In the case where the virtual address of the callee is designated by the caller client, the address determination unit 12c searches the address management table 12b with the designated combination of the virtual address and the service type as a key and determines the real address and the communication port of the callee.

The service provider 13 is a processing unit for providing various services to the clients 21, 22. In FIG. 1, the service provider 13 includes a first service processing unit 13a and a second service processing unit 13b. The first service processing unit 13a and the second service processing unit 13b provide different services. The first service processing unit 13a, for example, provides VolP to realize the speech through the IP network, and the second service processing unit 13b provides IM (instant message) to notify simple information.

The client 21, when conducting speech with the client 22 by VolP, for example, first designates the virtual address of the client 22 and the VolP service and transmits a communication start request to the server 10. The server 10 first searches the address management table 12b with the virtual address designated by the client 21, i.e. the virtual address of the client 22 and the service type, i.e. VolP as a key, and by specifying the real address of the client 22 and the communication port of the local device for communication with the client 22, notifies the service provider 13.

In the service provider 13, the first service processing unit 13a for providing the VolP service transmits a VolP communication start request to the client 22 using the real address and the communication port of the client 22 notified.

In this way, the server 10 manages the combination of the virtual address and the real address in correspondence with the service type and the communication port, and specifies the real address and the communication port from the combination of the virtual address and the service type. Even in the case where the client uses a plurality of services with the same virtual address, therefore, the port used for communication can be switched by identifying the service type. Thus, the server 10 can provide each service in a single process to the client using a plurality of services with the same virtual address.

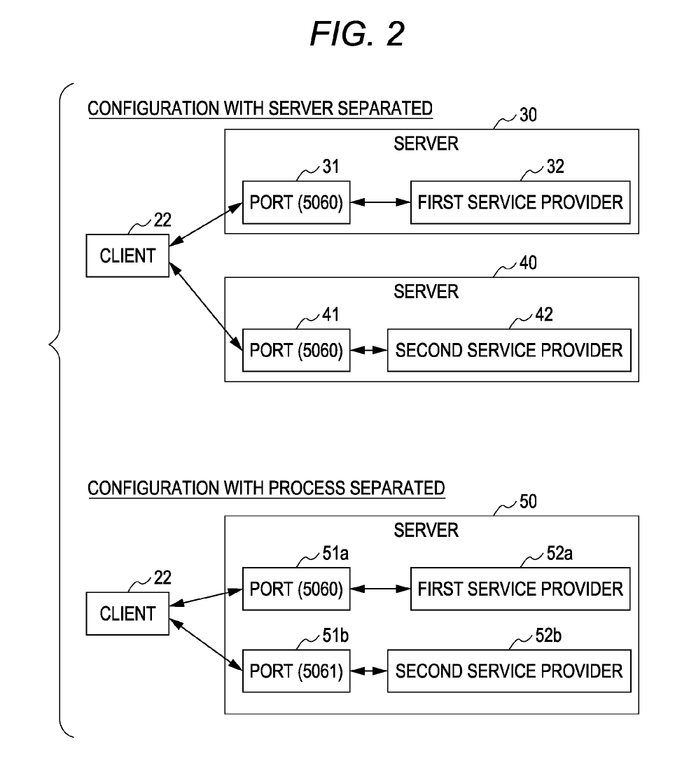

In the conventional configuration, as compared with the aforementioned configuration of the server 10, the server or the process is required to be separated for each service as shown in FIG. 2 in the case where a plurality of services are provided to a client with the same virtual address.

In the configuration with the server separated, the server 30 includes a port 31 and a first service provider 32, and the server 40 includes a port 41 and a second service provider 42. The first service provider 32 and the second service provider 42 provide different services. For example, the first service provider 32 provides the VolP service, while the second service provider 42 provides the IM service.

In this configuration with the server separated, the client 22 accesses the server 30 when using the VolP service, and the server 40 when using the IM service. Since the servers 30, 40 manage the address only for the service thus provided, respectively, each server holds only one pair of the virtual address and the real address of the client 22. Also, since the server 30 and the server 40 are arranged in housings independent of each other, the ports 31, 41 can have the same number.

In the configuration with the process separated, on the other hand, the server 50 includes ports 51a, 51b, and first and second service providers 52a, 52b. The first service provider 52a and the second service provider 52b execute different processes and provide different services. For example, the first service provider 52a provides the VolP service, and the second service provider 52b the IM service.

In this configuration with the process separated, the client 22 accesses the first service provider 52a through the port 51a when using the VolP service, and accesses the second service provider 52b through the port 52a when using the IM service. The first and second service providers 52a, 52b each manage the address only for the service provided thereby, respectively, and therefore, each holds only one pair of the virtual address and the real address of the client 22. Incidentally, since the first and second service providers 52a, 52b operate with the same server 50, the ports 51a, 51b use different numbers.

Thus, regardless of the configuration with the server or the process separated as described above, each service provider holds only one virtual address of the client 22. In the case where the client 22 receives a communication request from another client, therefore, the address and the port of the other party of communication can be specified by designation of only the virtual address. Nevertheless, the requirement of an increased number of resources for accommodation makes it difficult to provide the function over a plurality of services.

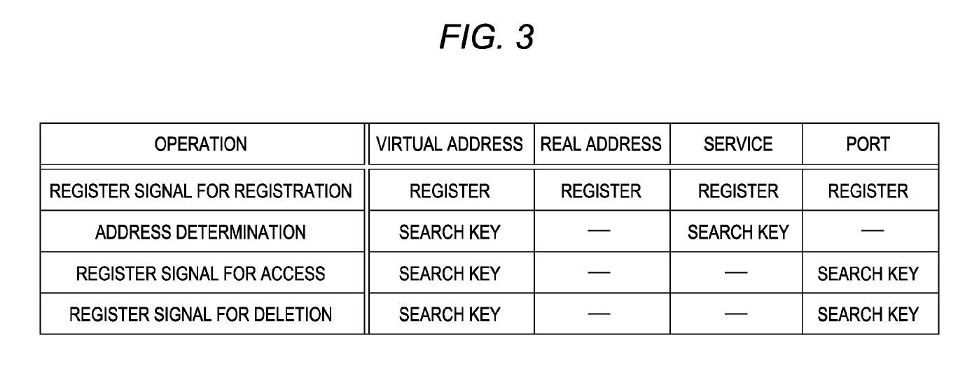

Next, the operation of the server 10 will be explained in detail. FIG. 3 is a diagram for explaining the address management operation executed by the address control unit 12 of the server 10. FIG. 3 assumes the VolP service using SIP defined in RFC 3261 and illustrates a case in which the address management of the clients 21, 22 is processed by a mechanism called REGISTER.

First, assume that the server 10 receives the REGISTER signal for registration from the clients 21, 22. The table management unit 12a registers the virtual address, the real address and the service type of the particular clients in the address management table 12b in correspondence with the communication port that has received the REGISTER signal for registration.

In the case where the server 10 receives the REGISTER signal for access from the clients 21, 22, on the other hand, the table management unit 12a searches the address management table 12b with the designated combination of the virtual address and the communication port as a key, and returns the real address and the service type obtained as the result of the search to the transmitting end of the REGISTER signal.

Similarly, in the case where the server 10 receives the REGISTER signal for deletion from the clients 21, 22, the table management unit 12a searches the address management table 12b with the designated combination of the virtual address and the communication port as a key, and deletes the registration information obtained as the result of the search.

In the case where the server 10 determines the address, as described already, the address determination unit 12c searches the address management table 12b with the combination of the virtual address and the service type as a key, and provides the service using the real address and the service type obtained as the result of the search.

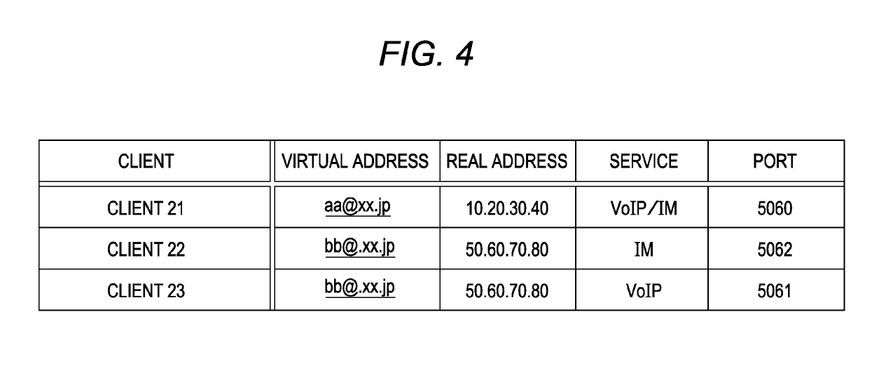

FIG. 4 is a diagram for explaining a specific example of the address management table 12b. In the case of FIG. 4, the client 21 has the virtual address aa@xx.jp and the real address 10.20.30.40, and uses the port number 5060 for both the VolP service and the IM service. The client 22, on the other hand, has the virtual address bb@xx.jp and the real address 50.60.70.80, and uses the port number 5061 for the VolP service and the port number 5062 for the IM service.

Specifically, the address information of the client 22 is registered individually for the VolP service and the IM service. Although the virtual address is the same for the VolP service and the IM service, the port to be used can be specified by identifying the service type.

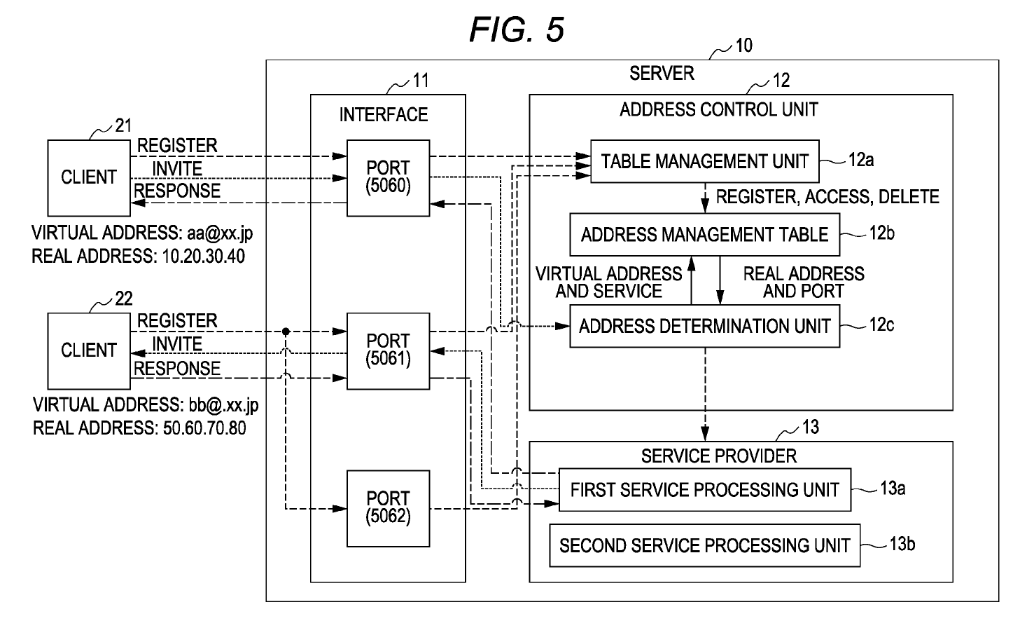

FIG. 5 is a diagram for explaining a specific example of the operation of the communication system shown in FIG. 1. In FIG. 5, the client 21 has the virtual address aa@xx.jp and the real address 10.20.30.40. The client 21 issues an address registration request by transmitting the REGISTER signal for registration collectively for both the VolP and IM services.

The server 10 accepts this REGISTER signal for registration at the port number 5060 of the interface 11. As a result, the table management unit 12a, as shown in FIG. 4, sets the VolP and IM services and the port number 5060 in the virtual address aa@xx.jp and the real address 10.20.30.40 of the client 21.

On the other hand, the client 22 has the virtual address bb@xx.jp and the real address 50.60.70.80. The client 22 issues an address registration request individually by transmitting the REGISTER signal for registration individually for the VolP and IM services.

The server 10 accepts the REGISTER signal for registration of the IM service at the port number 5062 of the interface 11 from the client 22. As a result, the table management unit 12a, as shown in FIG. 4, sets the IM service and the port number 5062 for the virtual address bb@xx.jp and the real address 50.60.70.80 of the client 22.

Also, the server 10 accepts the REGISTER signal for registration of the VolP service from the client 22 at the port number 5061 of the interface 11. As a result, the table management unit 12a, as shown in FIG. 4, sets the VolP service and the port number 5061 for the virtual address bb@xx.jp and the real address 50.60.70.80 of the client 22.

Consider a case in which the VolP communication start request is transmitted to the client 22 by the client 21 after setting the address information of the clients 21, 22. First, the client 21 transmits the INVITE, i.e. a communication start request to the port number 5060 of the server 10. In the process, the client 21 designates the virtual address bb@xx.jp and the service type VolP in the INVITE.

In the server 10, the real addresses 50, 60, 70, 80 of the client 22 and the port number 5061 used for VolP communication with the client 22 are specified by searching the address management table 12b with the combination of the virtual address bb@xx.jp and the service type as a key.

In this process, according to the conventional technique for executing the address determination only with the virtual address, the port to be used cannot be specified due to the presence of two registrations for the same virtual address bb@xx.jp. In the server 10, however, the use of the service type as a search key makes it possible to specify the port used in each service also for the client 22 having a plurality of registrations with the same virtual address.

In the service provider 13, the first service processing unit 13a in charge of VolP transfers the INVITE to the client 22 from the port number 5061.

The client 22 receives the INVITE transmitted by the client 21 and transferred by the server 10. Then, a response to the INVITE thus received is sent back. This response is sent to the first service processing unit 13a through the port number 5061 of the server 10, and then sent from the port number 5060, reaches the client 21.

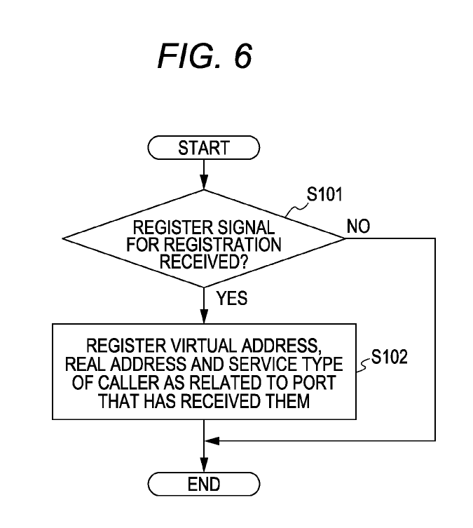

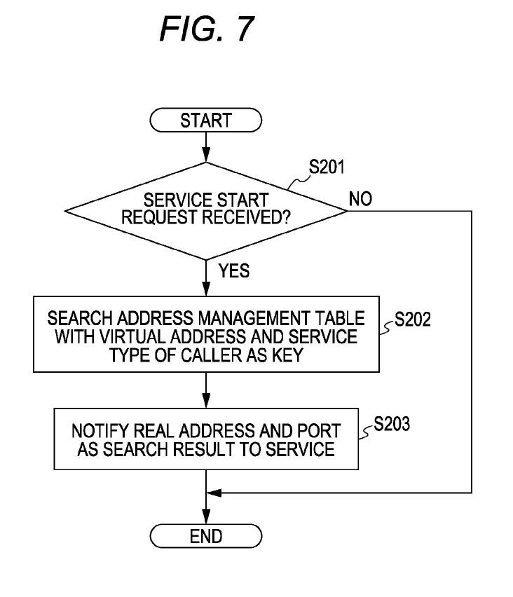

Next, with reference to FIGS. 6 and 7, the processing operation for address information registration and the address determination will be explained. The processing operation shown in FIG. 6 is the address information registration process executed by the table management unit 12a. The table management unit 12a, upon reception of the REGISTER signal for registration (YES in step S101) registers the virtual address, the real address and the service type of the transmitting party in correspondence with the port at which the REGISTER signal is received (S102) thereby to end the process.

The processing operation shown in FIG. 7 is the one for address information determination executed by the address information determination unit 12c. The address information determination unit 12c, upon reception of the INVITE which is a service start request (YES in S201) searches the address management table with the virtual address of the destination and the service type as a key (S202), and by notifying the corresponding service processing unit of the real address and the port number of the destination obtained as the search result (S203), ends the process. Incidentally, though not explained here, the service processing unit that has received the notification starts the service using the real address and the port number thus notified.

As explained above, at the time of address information registration, the server 10 registers the service type and the port number in correspondence with each other, and at the time of address determination, makes the search with the combination of the virtual address and the service type as a key. Therefore, even in the case where there exists a terminal unit using a plurality of services with the same virtual address, the port to be used for each service in a single process can be specified thereby to reduce the cost required to provide the service.

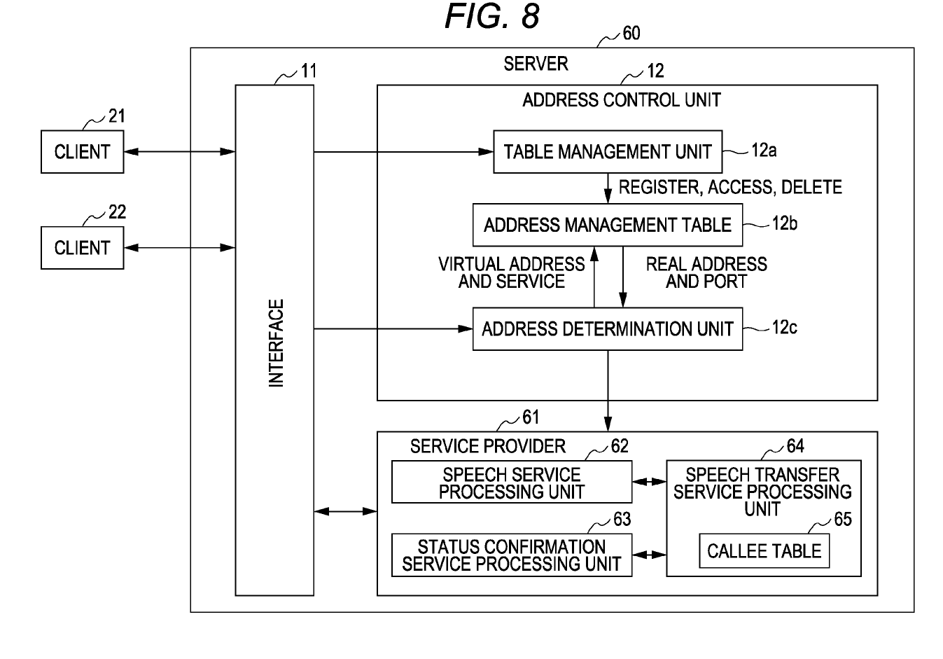

Next, the function of integrating and providing a plurality of services will be explained. FIG. 8 is a diagram showing the general configuration of the communication server device having the function of integrating and providing a plurality of services. In FIG. 8, a server 60 is connected with the clients 21, 22 constituting terminal units. Also, the server 60 includes therein an interface 11, an address control unit 12 and a service provider 61.

The clients 21, 22, the interface 11 and the address control unit 12 are identical with the component elements designated by the same reference numerals, respectively, in the communication system shown in FIG. 1, and therefore, not explained again.

The service provider 61 includes a speech service processing unit 62, a status confirmation service processing unit 63 and a speech transfer service processing unit 64. The speech service processing unit 62 corresponds to the first service provider 13a and provides VolP. Also, the status confirmation service 63 is a processing unit corresponding to the second service provider 13b and provides the IM service.

The speech transfer service processing unit 64 performs the function to integrally use the VolP service provided by the speech processing unit 62 and the IM service provided by the status confirmation service 63. Specifically, the speech transfer service processing unit 64 operates in such a manner that in the case where communication fails to be established in the speech service after transfer of the VolP communication start request, the status of the callee client is confirmed by the IM information notification service, and based on the result of the status confirmation, the INVITE transferee for the VolP service is changed.

The callee table 65 held by the speech transfer service processing unit 64 holds, in correspondence with each other, the status (status information) obtained as the result of the service by the status confirmation service processing unit 63 and the callee, i.e. the INVITE transferee of the VolP service.

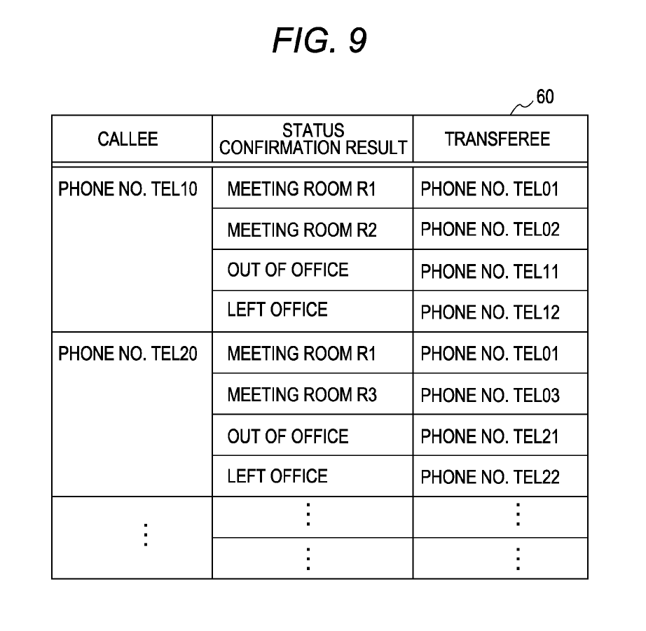

FIG. 9 is a diagram for explaining a specific example of the callee table 60. In the callee table 60 shown in FIG. 9, the callee is the virtual address designated as the other party of speech by the VolP caller. Also, the status confirmation result is the status obtained as the result of status confirmation by the status confirmation service processing unit 63, and the transferee is defined as the speech transferee corresponding to the status confirmation result.

In the case where the speech start request is sent to the telephone number TEL10 but the speech fails to be established, therefore, the status is confirmed. If the status “meeting room R1” is returned, the speech is transferred to the telephone number TEL01, while if the status “meeting room R2” is returned, the speech is transferred to the telephone number TEL02. Also, if the status “out of the office” is returned, the speech is transferred to the telephone number TEL11, and if the status “left the office” is returned, the speech transferred to the telephone number TEL12.

Similarly, in the case where the speech start request is sent to the telephone number TEL20 but the speech fails to be established, the status is confirmed. If the status “meeting room R1” is returned, the speech is transferred to the telephone number TEL01, while if the status “meeting room R3” is returned, the speech is transferred to the telephone number TEL03. Also, if the status “out of office” is returned, the speech is transferred to the telephone number TEL21, and if the status “left office” is returned, the speech is transferred to the telephone number TEL12.

The status acquisition, the selection of speech transferee and the speech selection are carried out automatically in the server. Therefore, the integral service is realized that “the speech is connected by the extension line if the callee is in the office, while the speech is connected by the outside line if the callee is not in the office, without the caller being conscious of the telephone number of the callee (with one telephone number)”.

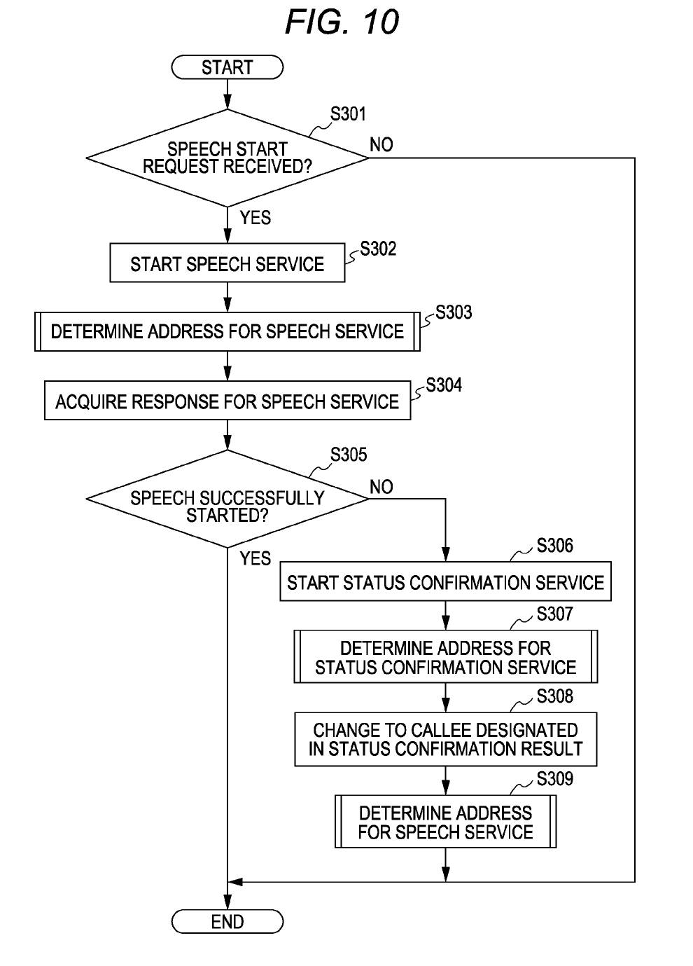

FIG. 10 is a flowchart for explaining the operation of the speech transfer service processing unit 64. The speech transfer service processing unit 64, upon reception of the speech start request (YES in S301), starts the speech service of the speech service processing unit 62 (S302). Then, the address determination unit 12c determines the address for the speech service (S303), and transfers the speech start request to the address and the port thus obtained.

After that, the speech transfer service processing unit 64 acquires the response for the speech service (S304) and in the case where the speech successfully starts (YES in S305), ends the transfer service and causes the speech service processing unit 62 to carry out the speed service.

In the case where the speech fails to start (NO in S305), on the other hand, the speech transfer service processing unit 64 starts the status confirmation service of the status confirmation service processing unit 63 (S306) and determines the address for the status confirmation service through the address determination unit 12c (S307).

The speech transfer service processing unit 64, based on the status obtained as the result of the status confirmation service, searches the callee table and changes the transferee of the speech start request to the corresponding callee (S308). Then, the speech transfer service processing unit 64 newly determines the address of the new transferee for the speech service (S309), and by transferring the speech start request to the address and the port thus obtained, ends the process.

The case has been explained above in which, where the speech to the address designated by the requesting party fails to start, the callee is automatically set by status confirmation. Upon reception of the speech start request, however, the status may be first confirmed and based on the status confirmation result, the callee may be set. In that case, upon reception of the speech start request in FIG. 10 (YES in S301), the process proceeds to the step of starting the status confirmation service (S306).

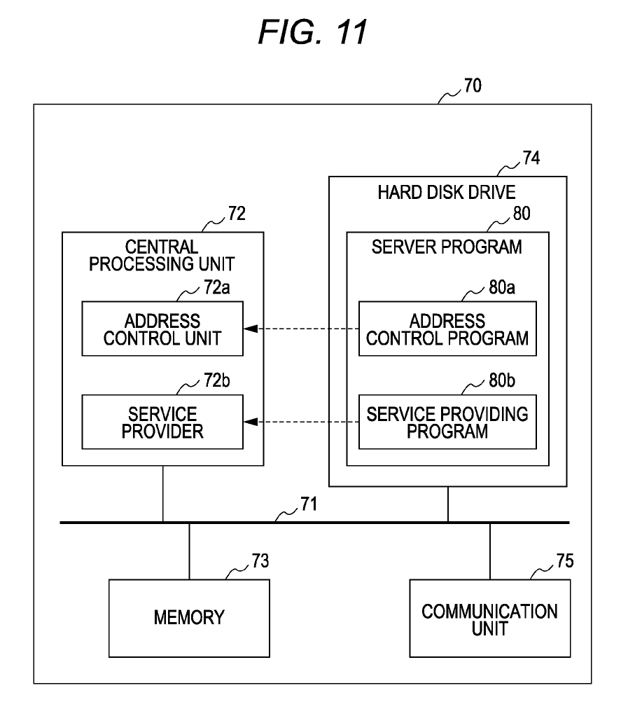

Also, each function in the configuration shown in FIGS. 1 and 8 may be implemented by either hardware or software. FIG. 11 is a diagram for explaining the program for the computer to operate as a communication server device.

A computer 70 shown in FIG. 11 is connected with a central processing unit (CPU) 72, a memory 73, a hard disk drive 74 and a communication unit 75 through a system bus 71.

The hard disk drive 74 stores a server program 80, which in turn includes an address control program 80a and a service providing program 80b.

The central processing unit 72 drives the computer 70 as a server by reading and executing the server program 80 from the hard disk drive 74. In the case where the address control program 80a constituting the server program 80 is read and executed, the central processing unit 72 functions as an address control unit 72a equivalent to the address control unit 12 shown in FIG. 1, while in the case where the service providing program 80b is read and executed, on the other hand, functions as a service provider 72b equivalent to the service provider 13 shown in FIG. 1.

As explained above, in the communication system according to this embodiment, the combination of the real and virtual addresses of the clients 21, 22 is stored in the address management table 12b in correspondence with the service type and the communication port. The address determination unit 12c specifies the port used for communication with the real address of the callee by searching the address management table 12b with the combination of the virtual address and the service type as a key. As a result, each of a plurality of services used by a client can be provided with the same virtual address in a single process. In this way, the communication server device, the address determination method and the address determination program are provided which can reduce the cost for providing the service and realize the integral function over a plurality of services.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. A communication server device comprising:
a management information registration unit for registering at least a combination of virtual addresses and real addresses of a plurality of terminal units as management information in correspondence with a service type and a communication port of the local device; and
an address determination unit for searching, upon reception of a communication start request designating the virtual address and the service type of any of the plurality of the terminal units from another terminal unit, the management information with the combination of the virtual address and the service type as a key and determining the real address and the communication port used as a transferee of the communication start request.

2. The communication server device according to claim 1, further comprising:
a speech transfer processing unit which, in the case where the communication fails to be established in the speech service after transfer of the communication start request for the speech service, confirms the status of the terminal unit constituting the callee in the information notification service and changes the transferee of the communication start request based on the status confirmation result.

3. The communication server device according to claim 1, wherein the management information registration unit, upon reception of an address registration request individually for a plurality of service types from a terminal unit having the same real and virtual addresses, assigns and individually registers different communication ports to the plurality of the service types.

4. The communication server device according to claim 1, wherein the management information registration unit, upon reception of an address registration request collectively for a plurality of service types from a single terminal unit, assigns and registers a single communication port for the plurality of the service types.

5. The communication server device according to claim 1, wherein the service type includes at least any one of the speech service between the terminal units and the information notification service between the terminal units.

6. The communication server device according to claim 1, wherein at least one of SIP (Session Initiation Protocol) and SIMPLE (SIP for Instant Messaging and Presence Leveraging Extensions) is used for the communication start request.

7. An address determination method for a communication server device, comprising:
registering at least a combination of virtual address and real address of a plurality of terminal units as management information in correspondence with a service type and a communication port of the local device; and
upon reception of a communication start request designating the virtual address and the service type of any of the plurality of the terminal units from another terminal unit, searching the management information with the combination of the virtual address and the service type as a key and determining the real address and the communication port used as a transferee of the communication start request.

8. An address determination program stored in a storage medium to cause a computer to execute a process including the steps of:
registering at least a combination of virtual address and real address of a plurality of terminal units as management information in correspondence with a service type and a communication port of the local device; and
upon reception of a communication start request designating the virtual address and the service type of any of the plurality of the terminal units from another terminal unit, searching the management information with the combination of the virtual address and the service type as a key and determining the real address and the communication port used as a transferee of the communication start request.
